(19) United States
(12) Patent Application Publication
(10) Pub. No.: US 2009/0084336 A1
(43) Pub. Date: Apr. 2, 2009

(54) Air intake system for internal combustion engine

(76) Inventor: Kenneth E. Friedl, West Covina, CA (US)

Correspondence Address: Boniard I. Brown, 1710 West Cameron Ave., #200, West Covina, CA, 91790, US

(21) Appl. No.: 11/906,340

(22) Filed: Oct. 2, 2007

(51) Int. Cl. F02M 35/104

(52) U.S. Cl. 123/184.55

(57) ABSTRACT

A stepless air intake system is disposed on a throttle body of an engine. Each of plural cylinders has an intake tract to funnel air for combustion.

### BACKGROUND AND SUMMARY OF THE INVENTION

An intake system for an internal combustion engine includes a variable length intake tract which adjusts to an infinite number of lengths, and has either one or two sliding funnels where one funnel of the intake tract slides within another and the ability to continuously be lengthened or shortened during engine operation to any needed length at any given time within the entire range of the intake tract. The starting point and longest position length of the intake tract of the air intake system, are at the engine's idle. The intake tract of said air intake system is capable of continuously and steplessly adjusting its length throughout the entire RPM range of the engine where its shortest position length will be at the engine's maximum operating speed, also known as the RPM redline.

The intake system may be arranged into any of several basic configurations. A first and primary configuration consists of the section of the intake tract having the smallest diameter as the base funnel, followed by the middle funnel which is the funnel having the second smallest diameter which is the middle section of the intake tract, and which slides up and down outside of the base funnel, finalized with the upper funnel which has the largest diameter set as the upper section of the intake tract and which slides up and down the outside of the middle funnel (FIG. 5). The intake system can be inverted in the event that the base funnel needs to be the largest diameter funnel of the intake tract, as an alternative and secondary configuration (FIG. 2). If there is very limited space, the intake system may be reduced to a two piece air intake funnel system having one stationary piece as the base funnel, and one sliding piece as the upper funnel, with no midele section funnel, as a modification to the primary three piece funnel configuration or a secondary inverted arrangement with one stationary piece as their base funnel and two sliding pieces as the middle and upper funnels (FIGS. 7 and 8).

In any configuration of the intake system, the base funnel may comprise directional cyclonic air fins, straight air channels, or nothing at all. The directional cyclonic air fin option will swirl the air into a cyclonic motion to further volatize the combining air/fuel mixture for increased fuel atomization and for more efficient combustibility of the air/fuel mixture. This cyclonic directional air fin option can be arranged to swirl the air in either a counter-clockwise direction for engines operating in the northern hemisphere, or in a clockwise direction for engines operating in the southern hemisphere due to the Coriolis effect of the earth (FIGS. 3a and 3b). The straight air channel option would be an opposite approach to that of the cyclonic air fin option, and would aid in directing air straight down by eliminating swirling air turbulence and further increasing air velocity resulting in an increase in air pressure into the cylinder (FIG. 6a). The third option for the base tube is to have nothing aiding air direction at all and leaving the base tube vacant and smooth (FIG. 6b).

The intake system is servo actuated through linkages connected to the upper intake funnel (or funnels) and is controlled by either the engine's central computer unit, or an additional programmable computer device. Each variable length intake funnel may have its own individual operating servo whereby in multiple cylinder engines each intake funnel may be adjusted independently (FIG. 4), or all the intake funnels may be connected to one another and actuated by one or two operating servos so that all the intake funnels move up and down simultaneously (FIG. 1).

During engine idle the intake tract is at its longest position. As the speed of the engine increases, the length of the intake tract will decrease upwardly until the engine's RPM redline where the intake tract is at its shortest length, and the length of the intake tract will be inversely proportional to the speed of the engine.

The effect of continuously manipulating the air resonance, caused by the difference in air pressure created by the engine's piston or pistons by being able to infinitely adjust the length of the intake tract allows for combustion efficiency to be maximized at any given engine speed.

The need for a variable length air intake device of this type is because of the nature of internal combustion engines, which have continuously changing timing of the intake valves which is directly proportional to the speed of the engine. The unlimited adjustability of the length of the intake tract of the air intake system makes this device superior to other variable length intake devices because this device will allow the frequency of the created airwave to be infinitely manipulated so that the wave which returns back into the base of the intake tract and into the throttle body, which intake tract will be affixed, will always be timed accurately so that the extra air pressure the wave produces can be forced into the cylinder just before the motor intake valves close at any given engine speed. The air intake system will take advantage of this airwave phenomenon through the constant manipulation of air resonance by way of infinitely lengthening and shortening the intake tract, which would not be possible without said intake system. This will increase combustion pressure at all engine speeds and in turn increase power and torque output throughout the entire RPM range of the motor.

### BRIEF DESCRIPTION OF THE SEVERAL VIEWS OF THE DRAWINGS

FIG. 1 is a perspective view of the preferred embodiment of the air intake system of the present invention;

FIG. 2 is a sectional view of a preferred embodiment of the present invention;

FIGS. 3A and 3B are sectional views taken at line 3-3 in FIG. 2;

FIG. 4 is a perspective view of an embodiment of the present invention;

FIG. 5 is a sectional view showing a servo for lowering the height of an upper funnel;

FIGS. 6A and 6B are sectional views taken at line 6-6 in FIG. 5;

FIG. 7 is a sectional view of another and simplified embodiment of the present invention; and

FIG. 8 is a sectional view showing a simplified embodiment of the device of FIG. 5.

### DETAILED DESCRIPTION OF THE INVENTION

The present invention may be referred to as a stepless telescopic air intake system (STAIS), which system is affixed on top of a throttle body with which all modern day fuel injected piston engines are equipped.

Referring to the drawings, each individual cylinder has its own individual throttle body, and each individual throttle body has its own individual intake tract. Herein there is specific discussion of the type of intake tracts which are in the form of straight funnels with bell-shaped end openings. These intake funnels are also known as “trumpets”, and serve to funnel pressurized air from an “air box” into a cylinder for combustion efficiency.

The length of the funnel determines the frequency of the air resonance caused by vacuum compression of a piston. When the piston drops to the bottom of the cylinder, a partial Vacuum is created which produces a rapid movement of air to fill the void created in the cylinder. This action creates an air wave that deflects rapidly up and down the intake tract, thus creating air resonance.

The frequency of this air resonance is determined by the length of intake tract. If the deflected air wave is timed to crash back into the cylinder just before the intake valves close, then the extra air pressure in the cylinder caused by this crashing air wave will maximize combustion efficiency, thus increasing the torque and power output of the engine. The only problem is that modern day intake trumpets are either of one fixed length, or have been designed to be able to change between two fixed lengths. This means that the frequency of the air wave cannot be manipulated to accommodate all engine speeds because the rate at which the intake valves of a motor open and close is directly proportional to the speed of the engine.

In order to constantly and infinitely manipulate the frequency of the piston's created air resonance, the intake tract must be steplessly and continuously lengthened and shortened. The STAIS air intake system allows for infinitely adjustable trumpets. The STAIS funnels will be at their extended length positions when the engine is at idle, and at their shortest length position when the engine is at maximum engine speed.

The intake tract may be lengthened or shortened in such manner at any time to any length along the spectrum of the tract, thus to accommodate varying engine speeds caused by inputs of the human operator of the machine.

Silicone O-rings are provided for proper friction of the sliding funnels, as well as to seal off unwanted air flow.

In operation at engine idle, the intake funnels 8 are at their extended positions. With engine speed increase, the engine central computer or a supplemental computer control unit (not shown), sends a signal to an operating servo which is connected to an upper funnel or funnels 10 via mechanical linkages.

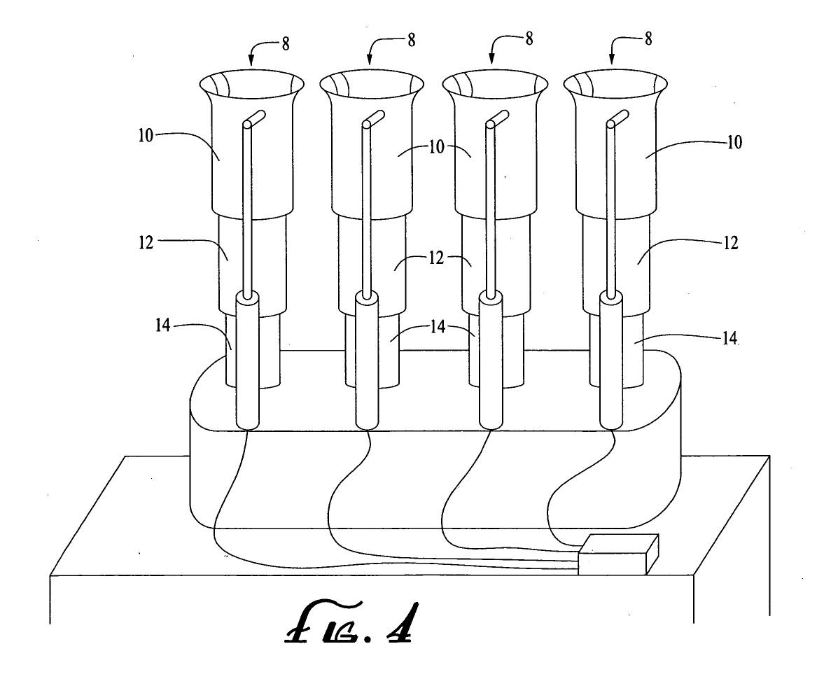

A servo (FIG. 5) then lowers the height of the upper funnel 10 according to the increasing engine speed. With engine speed increase, the upper funnel 10 is lowered by sliding down the outside of the middle funnel 12 until the bottom edge of the upper funnel 10 abuts the middle funnel's lower outer flange 16, whereupon the middle funnel 12 begins to lower, sliding down the outside of the base funnel 14 to continue the shortening of the length of an intake tract. When the middle funnel's lower outer flange 16 abuts against the base, the engine is at its maximum speed and the intake tract is at its shortest position.

As engine speed decreases, the height of upper funnel 10 is raised by the operating servo, sliding up the exterior of the middle funnel 12 until the upper funnel flange 20 abuts against the middle funnel's upper flange 22, whereupon the middle funnel 12 begins to slide up the outside of base funnel 14 to continue the lengthening of the intake tract until the middle funnel's inner flange 24 abuts the base funnel's flange 26, whereupon the engine will be operating at idle speed and the intake tract will be back in its longest position.

In this manner, the length of the intake funnels will be inversely proportional to the speed of the engine. This action of the intake trumpets would constantly and infinitely manipulate the frequency of the created air wave so that the air wave is always timed accurately to crash back into the cylinder just before the intake valves close no matter what the operating speed of the engine is. This will allow combustion efficiency to be maximized at any engine speed.

STAIS will be servo actuated through mechanical linkages and controlled by the engines central computer or a supplemental computer control unit.

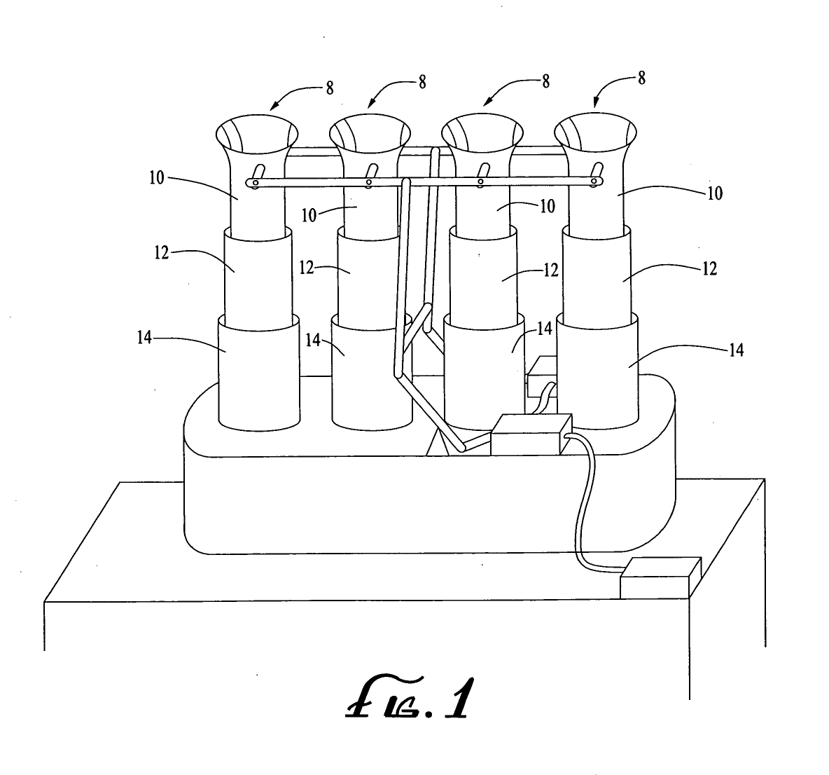

Referring to FIG. 1, in multi-cylinder engine configurations all upper funnels may be connected to each other so that one or two operating servos may move all intake funnels up and down simultaneously.

Referring to FIG. 4, in multi-cylinder engine configurations each individual intake funnel may have its own individual operating servo, so that if need be, each intake funnel may move up and down independently from one another.

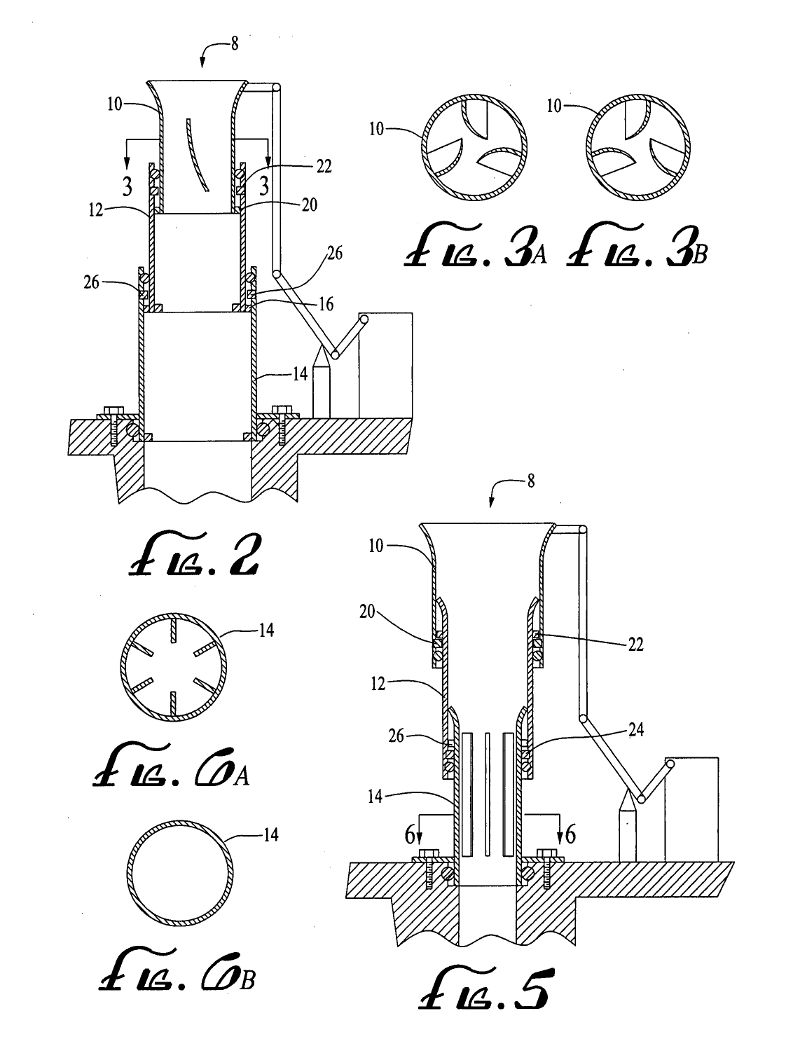

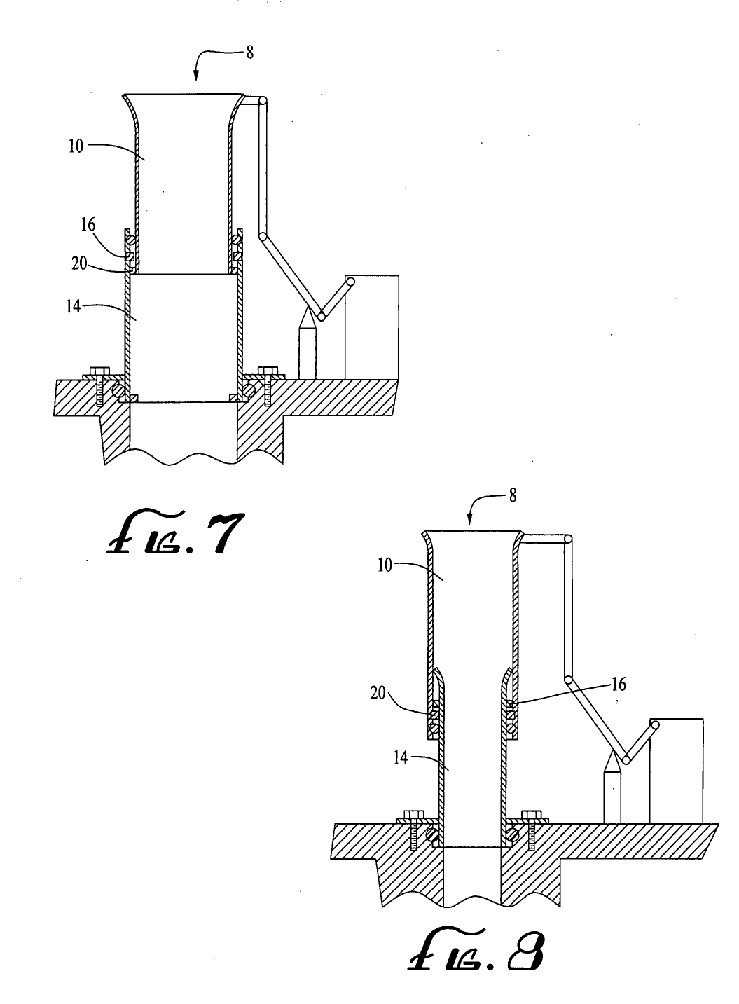

Referring to FIG. 5, a tri-segment configuration, the base funnel is the funnel of the smallest diameter and is affixed on top of the funnel injection throttle body. The base funnel is stationary and may have the option of directional cyclonic air fins (FIGS. 3A, 3B), straight air channels (FIG. 6A), or vacant and smooth (FIG. 6B). Towards the top of the base funnel is disposed a flange on the outside of the funnel. Above the flange is a groove in which will be a removable silicone O-ring. The end of the funnel will flare out to create a bell end that will extend exactly as far out as the flange.

The middle funnel is the funnel with the second smallest diameter and slides up and down the outside of the base funnel. The middle funnel has the most flanges (three). There are two flanges towards the bottom of the middle funnel, one on the outside of the funnel and one on the inside. The third flange is towards the top of the funnel on the outside. Above the upper flange will be a groove and in that groove will be a removable silicone O-ring. The end of the funnel will flare out to create a bell end that will extend as far out as the upper flange on this funnel.

The upper funnel is the funnel with the largest diameter, and slides up and down the outside of the middle funnel. There will be a flange towards the bottom of the upper funnel on the inside. The end of the upper funnel will flare out to create a bell end. The bell may extend as far as needed. The linkage that connects the electronic servo/servos to the funnels will be attached to a linkage ball affixed to the outside of the upper funnel.

Referring to FIG. 8, in situations where a tri-segment funnel configuration cannot be utilized due to limited space, a dual-segment funnel configuration may be used instead.

It will be understood that various changes and modifications may be made from the preferred embodiment discussed above without departing from the scope of the present invention, which is established by the following claims and equivalents thereof.

1. A stepless telescopic air intake system affixed atop a throttle body of a fluid injected piston engine.

2. An air intake system according to claim 1, wherein each of a plurality of cylinders has an individual throttle body intake tract in the form of funnels which serve to funnel air into a cylinder for combustion efficiency.

3. An air intake system according to claim 2, wherein the length of said funnels determines the frequency of the air resonance caused by vacuum compression of a piston.

4. An air intake system according to claim 3, wherein upon said piston dropping to the bottom of a cylinder a partial vacuum is created to cause air movement to fill a void created in the cylinder and to create an air wave to deflect rapidly up and down an intake tract to create air resonance.

5. An air intake system according to claim 4, wherein to manipulate the frequency of the piston's created air resonance, the intake tract must be steplessly and continuously lengthened and shortened.
